(19) United States
(12) Patent Application Publication
(10) Pub. No.: US 2026/0229683 A1
(43) Pub. Date: Aug. 6, 2026

(54) METHOD OF MANUFACTURING BATTERY PACK

(71) Applicant: TOYOTA JIDOSHA KABUSHIKI KAISHA, Toyota-shi (JP)

(72) Inventor: Nobuyuki YAMAZAKI, Okazaki-shi, (JP)

(73) Assignee: TOYOTA JIDOSHA KABUSHIKI KAISHA, Toyota-shi (JP)

(21) Appl. No.: 19/335,762

(22) Filed: Sep. 22, 2025

(30) Foreign Application Priority Data
Feb. 3, 2025 (JP) 2025-015997

(51) Int. Cl. H01M 50/296; H01M 50/249

(52) U.S. Cl. CPC H01M 50/296; H01M 50/249; H01M 2220/20

(57) ABSTRACT

First and second battery cells are arrayed adjacently in a battery stack. A first terminal that is a positive or negative external terminal of the first battery cell is provided on an end face of the first battery cell, and a second terminal that is a positive or negative external terminal of the second battery cell and paired with the first terminal is provided on an end face of the second battery cell facing the end face of the first battery cell. Next, a constraining load is applied to the battery stack from both side faces in a direction of array of the first and the second battery cells, with the first terminal and the second terminal in contact. Next, the battery stack is housed in a battery case with the first terminal and the second terminal in contact with each other and also the constraining load applied.

### CROSS-REFERENCE TO RELATED APPLICATION

This application claims priority to Japanese Patent Application No. 2025-015997 filed on February 3, 2025. The disclosure of the above-identified application, including the specification, drawings, and claims, is incorporated by reference herein in its entirety.

### BACKGROUND

### TECHNICAL FIELD

The present disclosure relates to a method of manufacturing a battery pack (battery package) to be installed in a vehicle.

### DESCRIPTION OF RELATED ART

Japanese Unexamined Patent Application Publication No. 2021-140874 (JP 2021-140874 A) discloses a method of manufacturing a battery module in which a battery stack is housed in a battery case. In this conventional method, shims are disposed between the battery case and the battery stack such that the battery stack is maintained in a pressurized state by inner faces of the battery case that are located at both ends of the battery stack in a longitudinal direction. The purpose of disposing these shims is to absorb dimensional variance in the battery stack in the longitudinal direction, and to ensure that the battery stack is pressurized by the inner faces of the battery case.

### SUMMARY

Now, each of a plurality of battery cells making up the battery stack is provided with positive and negative external terminals. These external terminals are electrically connected among the battery cells. This electrical connection is established via bus bars provided on side faces of the battery stack that is housed in the battery case.

However, when bus bars are provided on side faces of a battery stack, there is a problem in that two battery cells that have been brought close together by pressure will end up being separated by the length of the bus bars connecting the external terminals of these battery cells. In particular, while increasing the total number of battery cells that make up a battery stack can increase a cell filling rate and improve energy density of the battery stack, there is a problem in that the presence of the bus bars becomes a hinderance.

One object of the present disclosure is to provide technology that is capable of improving the energy density of a battery stack housed in a battery case in a state under pressure.

The present disclosure relates to a method of manufacturing a battery pack including a battery stack that is housed in a battery case, and has the following features.

The method according to the present disclosure includes arraying first and second battery cells adjacently to each other in a battery stack. Here, a first terminal that is a positive or negative external terminal of the first battery cell is provided on an end face of the first battery cell, and a second terminal that is a positive or negative external terminal of the second battery cell and that is paired with the first terminal is provided on an end face of the second battery cell facing the end face of the first battery cell. The method according to the present disclosure also includes applying a constraining load to the battery stack from both side faces in a direction of array of the first and the second battery cells. Here, the constraining load is applied in a state in which the first terminal and the second terminal are in contact with each other. The method of the present disclosure further includes housing the battery stack in the battery case. Here, the battery stack is housed in the battery case in a state in which the first terminal and the second terminal are in contact with each other and also the constraining load is applied.

In the present disclosure, the first terminal may include a terminal face that is parallel to the end face of the first battery cell, and the second terminal may include a terminal face that is parallel to the end face of the second battery cell. In this case, the method according to the present disclosure may further include positioning the terminal face of the first terminal and the terminal face of the second terminal, following the arraying of the first and the second battery cells and prior to the applying of the constraining load to the battery stack.

In the present disclosure, a shape of the first terminal may be a shape that engages with the second terminal. In this case, the method according to the present disclosure may further include engaging the first terminal and the second terminal, following the arraying of the first and the second battery cells and prior to the applying of the constraining load to the battery stack.

In the present disclosure, the battery stack may include a plate member that is provided between the end face of the first battery cell and the end face of the second battery cell. In this case, an area of an end face of the plate member facing the end face of the first battery cell may be smaller than an area of the end face of the first battery cell, and an area of an end face of the plate member facing the end face of the second battery cell may be smaller than an area of the end face of the second battery cell. Also, the first terminal may be provided outside a region on the end face of the first battery cell that faces the end face of the plate member, and the second terminal may be provided outside a region on the end face of the second battery cell that faces the end face of the plate member.

In the present disclosure, a sum of a thickness of the first battery cell in the direction of array of the first and the second terminal and a thickness of the second battery cell in the direction of array may be equal to or greater than a thickness that is set in advance as a distance between the end face of the first battery cell and the end face of the second battery cell in the direction of array when the battery stack is housed in the battery case, and also may be equal to or smaller than a thickness in the direction of array of a plate member that is disposed between the end face of the first battery cell and the end face of the second battery cell.

According to the present disclosure, when the constraining load is applied to the battery stack from both side faces in the direction of array of the first and the second terminals, the constraining load is applied to the battery stack in a state in which the first terminal and the second terminal are in contact with each other. Also, the battery stack is housed in the battery case in a state in which the first terminal and the second terminal are in contact with each other, and also in a state in which the constraining load is applied. As a result, the first and the second terminals of the battery stack continue to be in contact with each other after being housed in the battery case.

Accordingly, electrical connection between the first and the second terminals can be established without providing a bus bar on the side face of the battery stack. This means that the bus bar no longer has to be provided, and accordingly is expected to improve manufacturing efficiency of battery packs. Also, reducing the thickness of the first and the second terminals in the direction of array enables the total number of battery cells making up the battery stack to be increased, thereby improving the energy density of the battery stack.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a typical method of manufacturing a battery pack ;

FIG. 2 is a diagram illustrating a problem with the method of manufacturing the battery pack that is described in FIG. 1;

FIG. 3 is a diagram illustrating an example of a configuration of a battery cell to which a method according to an embodiment is applied;

FIG. 4 is a diagram illustrating a first example of the method according to the embodiment; and

FIG. 5 is a diagram illustrating a second example of the method according to the embodiment.

### DETAILED DESCRIPTION OF EMBODIMENTS

An embodiment of the present disclosure will be described below with reference to the drawings. However, structures and the like described in the following embodiments are not necessarily essential to the present disclosure, unless otherwise specified or clearly identified in principle.

The battery pack that is manufactured by a method according to the embodiment of the present disclosure is to be installed a vehicle. Examples of such vehicles include battery electric vehicles (BEVs), hybrid electric vehicles (HEVs), plug-in hybrid electric vehicles (PHEVs), and so forth, which travel on power that is supplied from a battery pack. The battery pack is attached, for example, to an underbody of the vehicle.

FIG. 1 is a diagram illustrating an example of a typical method of manufacturing a battery pack. FIG. 1 illustrates a lower case 11 of a battery pack 1. The lower case 11 is combined with an upper cover, which is omitted from illustration, to make up the battery pack 1. Note that an X-axis in FIG. 1 corresponds to, for example, a front-rear direction of the vehicle, and a Y-axis that is orthogonal to the X-axis corresponds to, for example, a right-left direction of the vehicle. More specifically, a positive direction of the X-axis corresponds to a forward direction of the vehicle, and a positive direction of the Y-axis corresponds to a leftward direction of the vehicle.

In the example illustrated in FIG. 1, the lower case 11 has four spaces 12 that are formed in the X-axis direction. Three battery stacks 2 are respectively housed in three of these spaces 12. These battery stacks 2 are formed by stacking a plurality of battery cells. A total number NC of battery cells making up one battery stack 2 is set in advance. The total number NC is, for example, 20 to 50.

FIG. 1 also illustrates one battery stack 2 outside of the lower case 11. In the example illustrated in FIG. 1, first, the battery cells are arrayed in a certain direction outside of the lower case 11. When arraying the battery cells in this manner, plate members are placed on side faces of the battery cells as appropriate. Examples of the plate members include cooling plates that have a function of cooling the battery cells. An assembly of a predetermined number (total number NC) of the battery cells that are arrayed corresponds to the battery stack 2 that is illustrated in FIG. 1.

In the example illustrated in FIG. 1, a constraining load is then applied to these battery cells from both side faces in a direction of array of the battery cells. This means that a constraining load is applied to the stack of the battery cells (i.e., battery stack 2) from both side faces in a stacking direction of these battery cells (i.e., the longitudinal direction of battery stack 2). Next, the battery stack 2 is inserted into the space 12 while maintaining the state in which the constraining load is applied to the battery stack 2. Thus, the battery stack 2 is housed in the lower case 11.

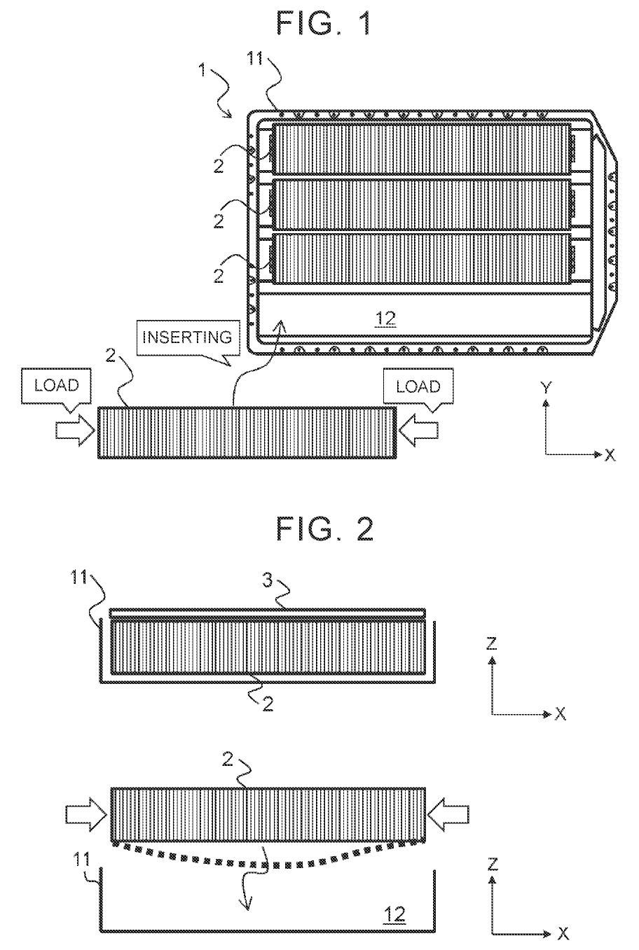

The method that is described with reference to FIG. 1 is also called “cell-to-pack (CTP) method”. The CTP method has the advantage of being able to increase a cell filling rate as compared to module-to-pack method, in which the battery cells are assembled into a module, following which constraining members are used to manufacture the battery pack. However, the CTP method has the following problems. This problem will be described with reference to FIG. 2. The upper side of FIG. 2 is a diagram illustrating a first problem. The upper side of FIG. 2 illustrates the battery stack 2 that is housed in the lower case 11 by the method described with reference to FIG. 1. Note that the Z-axis in FIG. 2 corresponds to, for example, an up-down direction of the vehicle. More specifically, the positive direction of the Z axis corresponds to an upward direction of the vehicle.

In the example that is illustrated in the upper side of FIG. 2, a bus bar 3 is attached to the battery stack 2 that is housed in the lower case 11. The bus bar 3 is a conductive member for electrically connecting among the battery cells, such as connecting an external terminal (e.g., a positive terminal) of a first battery cell to an external terminal (e.g., a negative terminal) of a second battery cell that is adjacent to the first battery cell, and also connecting an external terminal (e.g., a positive terminal) of the second battery cell to an external terminal (e.g., a negative terminal) of a third battery cell that is adjacent to the second battery cell.

However, when the bus bar 3 is provided, two battery cells that have come close to each other due to the application of the constraining load will move apart by a distance equivalent to the length of the bus bar 3 connecting these battery cells. In particular, when the total number NC of battery cells making up the battery stack 2 increases, a cell filling rate Φ (e.g., total volume of battery cells / volume of battery stack 2) can be increased and energy density of the battery stack 2 can be improved, but there is a problem that the presence of the bus bar 3 is a hinderance thereto.

The lower side of FIG. 2 is a diagram illustrating a second problem. As already described, the constraining load is applied to the battery stack 2 when being inserted into the lower case 11. A direction of the load vector in which this constraining load is applied is a direction perpendicular to the direction of gravity. However, the direction of the load vector readily changes due to the large number of components (battery cells, plate members) that make up the battery stack 2, and dimensional variance in these components. Also, due to the effect of gravity on the battery stack 2, the battery stack 2 readily sags in the direction of gravity (negative direction of Z axis). This poses a problem in that maintaining a constant bearing of the battery stack 2, in a state in which the constraining load is applied, while inserting into the space 12, is difficult.

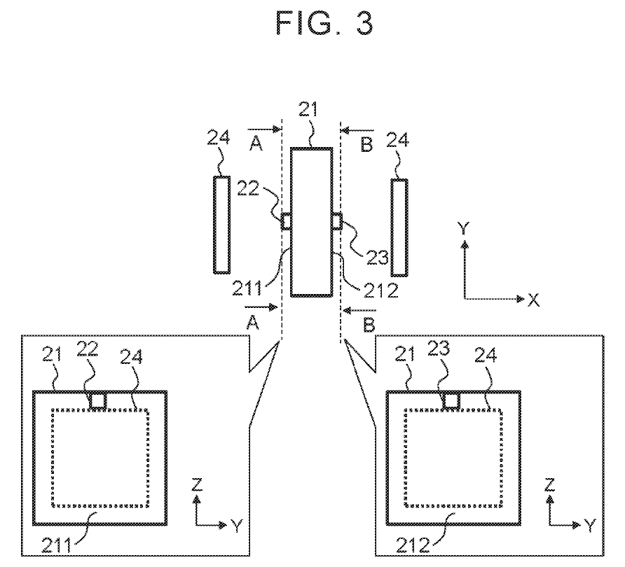

Therefore, in the method according to the embodiment, the external terminals to be provided to the battery cells are provided on the end faces of the battery cells in the direction of array. A constraining load is then applied to the battery stack 2 in a state in which the external terminals of two adjacent battery cells that are in contact with each other. FIG. 3 is a diagram illustrating an example of a configuration of a battery cell to which the method according to the embodiment is applied. In the example illustrated in FIG. 3, an external terminal (e.g., positive terminal) 22 is provided on an end face 211 of the battery cell 21, and an external terminal (e.g., a negative terminal) 23 is provided on an end face 212 of the battery cell 21.

Both of the external terminals 22 and 23 have a plate-like shape. The external terminals 22 and 23 have the same size. Thickness of each of the external terminals 22 and 23 in the direction of array the battery cells 21 is equal to or less than half of thickness of each of plate members 24 (e.g., cooling plates) provided adjacently to the end faces 211 and 212. Also, the thickness of each of the external terminals 22 and 23 is equal to or greater than half a distance (design value) between the end face 211 and the end face 212 when the battery stack 2 is housed in the lower case 11. That is to say, the total thickness of the external terminals 22 and 23 is equal to or greater than the distance between the end face 211 and the end face 212 when the battery stack 2 is housed in the lower case 11, and also is equal to or less than the thickness of the plate members 24.

FIG. 3 also includes an arrow view drawing of the end face 211 along line A-A, and an arrow view drawing of the end face 212 along line B-B. As can be seen from the arrow view drawing along line A-A, the end face 211 and an end face of the plate member 24 that is disposed adjacently thereto are both square in shape, but the area of the latter is smaller than the area of the former. Each of the external terminals 22 is situated outside a region of the end face 211 that faces the end face of the plate member 24. Accordingly, it can be said that a region for providing the external terminal 22 is secured on the end face 211. The same can be understood from the arrow view diagram of the end face 212 along line B-B. That is to say, a region for providing the external terminal 23 is secured on the end face 212.

In the example illustrated in FIG. 3, the external terminals 22 and 23 are each located at the middle of end portions of the end faces 211 and 212 in the Z-axis direction. In the Y-axis and Z-axis directions, the position of the external terminal 22 matches the position of the external terminal 23. Accordingly, when the battery cells 21 are arrayed, the external terminal 22 (e.g., positive terminal) and the external terminal 23 (e.g., negative terminal) that is paired therewith, face each other between two battery cells 21 (first and second battery cells) that are adjacent to each other. Note that the positions of the external terminals 22 and 23 can be changed to any position as long as these positions match each other on a Y-Z plane (e.g., plane perpendicular to direction of array of battery cells).

Also, the shape of the end face of each of the plate members 24 illustrated in FIG. 3 is only one example, and the shape can be optionally modified as long as the external terminals 22 and 23 and the plate members 24 do not interfere with each other. For example, the shape of the end face of the plate member 24 may be such that the lengths of two of the four sides making up the end face of the plate member 24 are equal to those of the end face 211 (or the end face 212), and such that portions corresponding to the regions where the external terminals 22 and 23 are provided are narrow (rectangular). Alternatively, the lengths of all four sides making up the end face of the plate members 24 may be equal to those of the end face 211 (or end face 212), with just the regions where the external terminals 22 and 23 are provided notched out (hole-shaped).

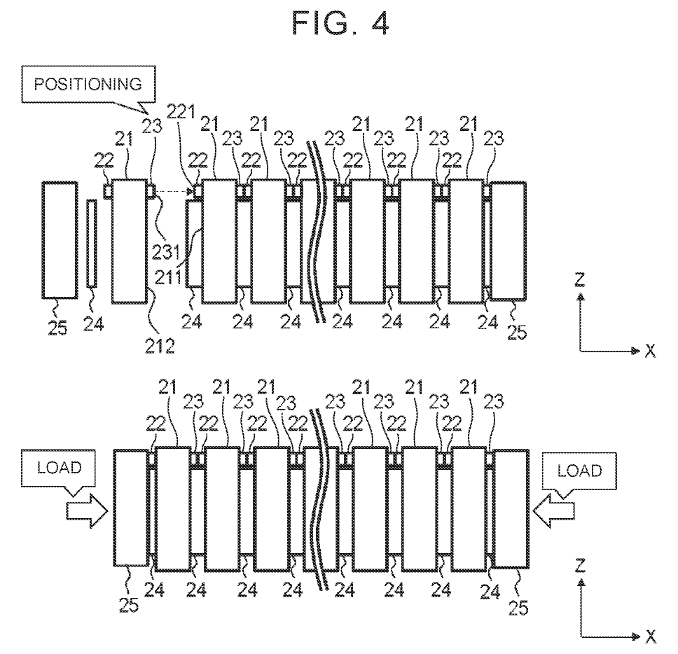

FIG. 4 is a diagram illustrating a first example of the method according to the embodiment. In this first example, the battery cells 21 that are described with reference to FIG. 3 are used. The battery cells 21 are arrayed in the certain direction (e.g., X-axis direction). During the arraying thereof, positioning is performed regarding a terminal face 221 of the first external terminal 22 (first terminal) that is provided on the first battery cell 21 (first battery cell) and a terminal face 231 of the second external terminal 23 (second terminal) that is provided on the second battery cell 21 (second battery cell). Now, the second battery cell 21 is the battery cell 21 that faces the first battery cell 21, and the second external terminal 23 thereof forms a pair with the first external terminal 22. Also, the terminal face 221 is a face that, from among the end faces of the first external terminal 22, is parallel to the end face 211, and the terminal face 231 is a face that, from among the end faces of the second external terminal 23, is parallel to the end face 212.

As described with reference to FIG. 3, the position of the external terminal 22 matches the position of the external terminal 23 in the Y-axis and Z-axis directions. Accordingly, following arraying the battery cells 21, fixing one end face side of the battery stack 2 while moving these battery cells 21 in the direction of array from the other end face side of the battery stack 2 enables the terminal faces 221 of the first external terminals 22 and the terminal faces 231 of the second external terminals 23 to be easily positioned.

In the first example, the terminal face 221 and the terminal face 231 are positioned with each other, such that the external terminals 22 and 23 come into contact with each other. After all of the battery cells 21 have been positioned, a constraining load (approximately 10 to 20 kN) is applied to both side faces in the stacking direction of these battery cells (i.e., longitudinal direction of battery stack 2). Note that end plates 25 of the battery stack 2 are disposed on both side faces of the battery stack 2 to which the constraining load is applied. Therefore, the external terminal 22 (or external terminal 23 ) of the battery cell 21 that is adjacent to the end plate 25 comes into contact with an end face of the end plate 25.

In the first example, the battery stack 2 is then inserted into the space 12 while maintaining a state in which a constraining load (approximately 10 to 20 kN) is applied to the battery stack 2. This step is in common with the example that is described with reference to FIG. 1.

According to the first example, electrical connection can be established between the external terminals 22 and 23 without providing the bus bar 3 on the side face of the battery stack 2. That is to say, the first problem that is described above with reference to the upper side of FIG. 2 can be solved. This also leads to omission of the step of providing the bus bar 3, and accordingly is expected to improve manufacturing efficiency of the battery pack 1. Also, reducing the thickness of the external terminals 22 and 23 in the direction of array of the battery cells 21 enables the total number of battery cells 21 that make up the battery stack 2 to be increased, thereby improving the energy density of the battery stack 2.

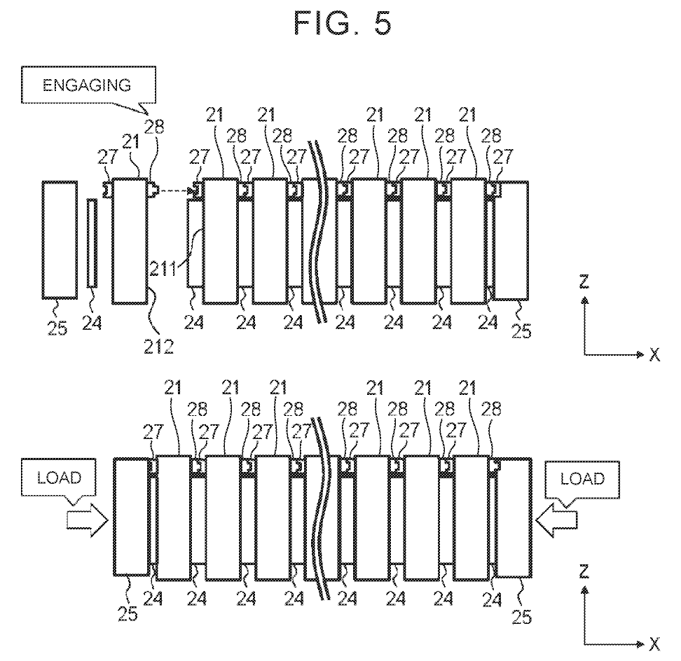

FIG. 5 is a diagram illustrating a second example of the method according to the embodiment. In this second example, battery cells 21 are used that have external terminals with a different shape from the external terminals 22 and 23 that are described in FIG. 3. That is to say, in the example illustrated in FIG. 5, the first battery cell 21 (first battery cell) is provided with a first external terminal 27 (first terminal) having a recessed shape. Also, the second battery cell (second battery cell) is provided with a second external terminal 28 (second terminal) having a protruding shape. Now, the second battery cell 21 is a battery cell 21 facing the first battery cell 21, and the second external terminal 28 thereof forms a pair with the first external terminal 27.

Note that the thickness of each of the first external terminal 27 and the second external terminal 28 in the direction of array of the battery cells 21 is based on a maximum value in this direction of array. This maximum thickness is designed to be equal to the thickness of the external terminals 22 and 23 that are described with reference to FIG. 3. Also, the shapes of the first external terminal 27 and the second external terminal 28 illustrated in FIG. 5 are only examples, and these shapes can be optionally modified as long as the first external terminal 27 and the second external terminal 28 can be engaged with each other. For example, when the first external terminal 27 has a stepped portion, the second external terminal 28 may have a stepped portion that engages with this stepped portion.

As described with reference to FIG. 3, the position of the external terminal 22 matches the position of the external terminal 23 in the Y-axis and Z-axis directions. This positional relation also holds true between the first external terminal 27 and the second external terminal 28. Accordingly, following arraying the battery cells 21, fixing one end face side of the battery stack 2 while moving these battery cells 21 in the direction of array from the other end face side of the battery stack 2 engages the first external terminals 27 and the second external terminals 28 with each other.

In the second example, the external terminals 27 and the external terminals 28 are engaged with each other, whereby the external terminals 27 and the external terminals 28 are in contact with each other. After this engagement has been completed for all of the battery cells 21, a constraining load (approximately 10 to 20 kN) is applied from both side faces in the longitudinal direction of the battery stack 2. Note that the contact relation between the external terminal 27 (or external terminal 28) of the battery cell 21 that is adjacent to the end plate 25 and the end face of the end plate 25 is the same as that between the external terminal 22 (or external terminal 23) and the end face of the end plate 25 that is described with reference to FIG. 4.

In the second example, the battery stack 2 is then inserted into the space 12 while maintaining a state in which a constraining load (approximately 10 to 20 kN) is applied to the battery stack 2. This step is in common with the example that is described with reference to FIG. 1.

According to the second example, the same effects as those of the first example can be obtained. In the second example, in addition to the above, an effect is expected from the engaging of the external terminals 27 and the external terminals 28. That is to say, according to the second example, the external terminals 27 and the external terminals 28 are engaged with each other, and accordingly the battery stack 2 can be inserted into the space 12 while maintaining a constant bearing in a state in which the constraining load is applied. That is to say, the second problem described above with reference to the lower side of FIG. 2 can be solved.

What is claimed is:

1. A method of manufacturing a battery pack including a battery stack that is housed in a battery case, the method comprising:
arraying first and second battery cells adjacently to each other in the battery stack, in which a first terminal that is a positive or negative external terminal of the first battery cell is provided on an end face of the first battery cell, and a second terminal that is a positive or negative external terminal of the second battery cell and that is paired with the first terminal is provided on an end face of the second battery cell facing the end face of the first battery cell;
applying a constraining load to the battery stack from both side faces in a direction of array of the first and the second battery cells, in which the constraining load is applied to the battery stack in a state in which the first terminal and the second terminal are in contact with each other; and
housing the battery stack in the battery case, the battery stack being housed in the battery case in a state in which the first terminal and the second terminal are in contact with each other and also in a state in which the constraining load is applied.

2. The method according to claim 1, wherein
the first terminal includes a terminal face that is parallel to the end face of the first battery cell, and
the second terminal includes a terminal face that is parallel to the end face of the second battery cell,
the method further comprising positioning the terminal face of the first terminal and the terminal face of the second terminal, following the arraying of the first and the second battery cells and prior to the applying of the constraining load to the battery stack.

3. The method according to claim 1, wherein
a shape of the first terminal is a shape that engages with the second terminal,
the method further comprising engaging the first terminal and the second terminal, following the arraying of the first and the second battery cells and prior to the applying of the constraining load to the battery stack.

4. The method according to claim 1, wherein
the battery stack includes a plate member that is provided between the end face of the first battery cell and the end face of the second battery cell,
an area of an end face of the plate member facing the end face of the first battery cell is smaller than an area of the end face of the first battery cell, and an area of an end face of the plate member facing the end face of the second battery cell is smaller than an area of the end face of the second battery cell, and
the first terminal is provided outside a region on the end face of the first battery cell that faces the end face of the plate member, and the second terminal is provided outside a region on the end face of the second battery cell that faces the end face of the plate member.

5. The method according to claim 1, wherein a sum of a thickness of the first terminal in the direction of array and a thickness of the second terminal in the direction of array is equal to or greater than a thickness that is set in advance as a distance between the end face of the first battery cell and the end face of the second battery cell in the direction of array when the battery stack is housed in the battery case, and also is equal to or smaller than a thickness in the direction of array of a plate member that is disposed between the end face of the first battery cell and the end face of the second battery cell.
